(19) United States
(12) Patent Application Publication
(10) Pub. No.: US 2003/0215346 A1
(43) Pub. Date: Nov. 20, 2003

(54) Non-eccentric devices

(76) Inventor: Jerome R. Lurtz, Oakland, MI (US)

Correspondence Address: DOBRUSIN & THENNISCH PC, 401 S OLD WOODWARD AVE, SUITE 311, BIRMINGHAM, MI, 48009, US

(21) Appl. No.: 10/426,419

(22) Filed: Apr. 30, 2003

Related U.S. Application Data
(60) Provisional application No. 60/380,101, filed on May 6, 2002.

(51) Int. Cl. F03C 2/00

(52) U.S. Cl. 418/227

(57) ABSTRACT

The present invention is an apparatus that includes a chamber rotor with a chamber and an extension rotor with an extension. The rotors are housed in a rotor case. A pressure cavity is at least transiently formed by the extension rotor and the chamber rotor. The present invention also includes a compressor that includes a chamber rotor with a chamber and an extension rotor with an extension where the extension is adapted to be received in the chamber when the rotors are synchronously rotated. The compressor also includes a power input shaft attached to the extension rotor and a gear assembly attached to the rotors that is adapted to insure the synchronous rotation of the rotors. A rotor case houses the rotors and has an intake port and an exhaust port. The present invention also includes an engine that is similar to the compressor and includes a spark plug. Methods of compressing, pumping and generating electricity and mechanical power are also part of the present invention.

### RELATED APPLICATIONS

This application claims benefit of U.S. provisional application No. 60/380,101, filed May 6, 2002.

### FIELD OF THE INVENTION

This invention relates to improved non-eccentric devices such as pumps, compressors, and especially engines.

### BACKGROUND OF THE INVENTION

Engines provide a generally effective method of converting chemical energy into mechanical energy; they may turn fossil fuels into power that can drive the wheels of an automobile or the propeller of a boat. There are two general types of engines: piston engines and turbine engines. Piston engines are very common and have been adapted to numerous tasks. They provide relatively high amounts of torque or drive power, while being of a medium weight. Piston engines have numerous drawbacks including having many moving parts, having poor fuel efficiency, and being the root cause of significant amounts of pollution, while also being costly to assemble. Piston engines utilize a to-and-fro motion of the piston to generate torque. Consequently, piston engines are termed eccentric. Their eccentric nature is the cause of many of their inefficiencies.

Turbine engines are also common, particularly in aircraft. Known turbine engines operate by forcing a fluid (gas or liquid) through the engine, thus turning the fan-blades of the turbine. Known turbines may be characterized as momentum turbines because they operate by transferring the momentum of the fluid to the fan blades of the turbine. The hallmark of a momentum turbine is that if the rotation of the fan blades is prevented, the flowing fluid will continue to flow through the engine around the fan blades. Essentially no back pressure is created through the engine.

Known turbine engines have desirably high power to weight ratios, but have poor fuel efficiency, are difficult to cool and have short operational life spans given the extreme operating conditions. Also, turbine engines are generally unsuitable for use in ground vehicles because of the complex transmission required to translate the high speed of the turbine into the low speed of the vehicle wheels. Because turbine engines utilize pure rotary motion of the fan blades to generate torque, turbine engines are termed non-eccentric engines.

A Wankel engine combines some of the advantages of piston engines and turbine engines but sacrifices fuel efficiency and torque, which are both quite poor. Wankel engines use a single rotor and an eccentric shaft that wobbles the rotor.

Known compressors/pumps include gear pumps and lobe pumps. Although they utilize rotors and rotary motion, these types of compressors/pumps have several drawbacks. Effectively, gear/lobe pumps accomplish pumping by drawing fluid from one reservoir and transporting it to another reservoir. They may be characterized as one-way transporting valves. At no point do the rotors cooperate to compress or pump the fluid. In addition, they are inefficient and have relatively poor rates of pumping/compression. Also, gear and lobe pumps cannot be adapted for use as an engine.

Consequently, the inventor has recognized the need for improved compressors, pumps and engines.

### SUMMARY OF THE INVENTION

The present invention is an apparatus that includes a chamber rotor with a chamber and an extension rotor with an extension. The rotors are housed in a rotor case. A pressure cavity is at least transiently formed by the extension rotor and the chamber rotor. The present invention also includes a compressor that includes a chamber rotor with a chamber and an extension rotor with an extension where the extension is adapted to be received in the chamber when the rotors are synchronously rotated. The compressor also includes a power input shaft attached to the extension rotor and a gear assembly attached to the rotors that is adapted to insure the synchronous rotation of the rotors. A rotor case houses the rotors and has an intake port and an exhaust port. The present invention also includes an engine that is similar to the compressor and includes a spark plug. Methods of compressing, pumping and generating electricity and mechanical power are also part of the present invention.

### BRIEF DESCRIPTION OF THE DRAWINGS

In the drawings:

FIG. 1 shows a cross-section of a device according to the present invention.

FIGS. 2A-2F show cross-sections of a compressor according to the present invention, including illustrating several different stages in the operation of the compressor.

FIGS. 3A-3C show cross-sectional and isometric views of an engine according to the present invention.

FIGS. 4A-C show a cross-section of an engine according to the present invention with operational zones demarcated.

FIGS. 5A-G show cross-sections of an engine according to the present invention, including illustrating several different stages in the operation of the engine.

FIG. 6 shows a cross-section of another embodiment of an engine according to the present invention.

### DETAILED DESCRIPTION

The present invention is a non-eccentric, internal combustion engine that can be used in place of traditional engines including piston engines, turbine engines, and Wankel engines. Furthermore, the present invention is also a high efficiency compressor that may be used in place of traditional compressors. The present invention may also be used as a pump.

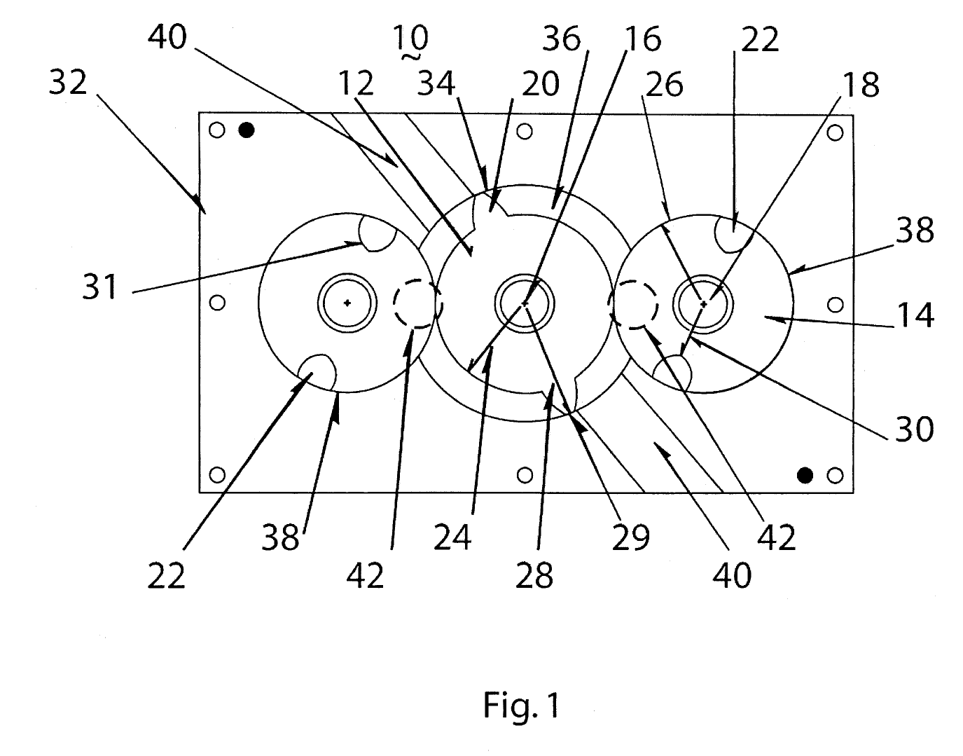

As seen in cross-section in FIG. 1, the non-eccentric device 10 of the present invention includes at least a pair of rotors 12, 14 that each has an axis of rotation 16, 18 at the center of mass of the rotor. The first rotor 12 includes at least one extension 20, and is termed the extension rotor. The extension 20 is generally a mound-shaped protrusion on the edge of the rotor. The positioning of the extension(s) on the circumference of the rotor is selected so that the rotor is balanced to provide pure rotary motion. For example, with two extensions, the extensions are located 180° from each other, while with three extensions, the extension are located 120° from each other. With a single extension, the axis of rotation is preferably placed to achieve pure rotary motion. The extension rotor of the present invention is non-eccentric and thus more like the fan blade of a turbine engine then the piston of a piston engine or the rotor in the Wankel engine.

The second rotor 14 includes at least one chamber 22, and is termed the chamber rotor. The chamber 22 is generally an indentation into the edge of the rotor that is adapted to accept the extension. Like the extensions, the chambers are positioned on the circumference of the rotor is selected so that the rotor is balanced to provide pure rotary motion. Typically, the number of chambers will be equal to the number extensions, although this is not necessarily the case because the rotors may be sized so that a two-extension rotor could be used with a one-chamber rotor or so that a three-extension rotor could be used with a two-chamber rotor. Thus, the relative number of extensions and chambers is not critical so long as the rotors may be synchronously rotated and the extension(s) does not substantially interfere with the rotor rotation when the rotors are placed adjacent to each other.

The rotors each have a base radius 24, 26 that defines the size of the rotor. The distance between the respective axes of rotation 16, 18 is about the sum of the base radii. The extension rotor 12 has an extension radius 28 that defines the distance from the axis of rotation 16 to the extension apex 29. The length of the extension is the difference between the base radius 24 and the extension radius 28. Likewise, the chamber rotor 14 has a chamber radius 30 that defines the distance to the chamber nadir 31 from the axis of rotation 18. The depth of the chamber is the difference between the base radius 26 and the chamber radius 30. The extension length and chamber depth may be equal in the compressor and pump aspects. In the engine aspect, this is not necessarily so. While typically circular in shape, rotor shape is not so limited and may have any shape, including shapes that are not regular polygons.

The shape of the extension and the chamber are complementary to each other such that during rotation of the rotors, the extension sweeps through the chamber without catching on the chamber rotor or otherwise interfering with the rotation of the rotors. The extension may range in shape from an arc without discontinuities to a pair of arcs that meet at a discontinuity to a pair of arcs separated by an intermediate surface. Other shapes may also be suitable such as fins or vanes. An extension with a single discontinuity is preferred for the compressor aspect, while an extension with an intermediate surface is preferred for the engine aspect. The motion of the extension apex generally defines the shape of the chamber.

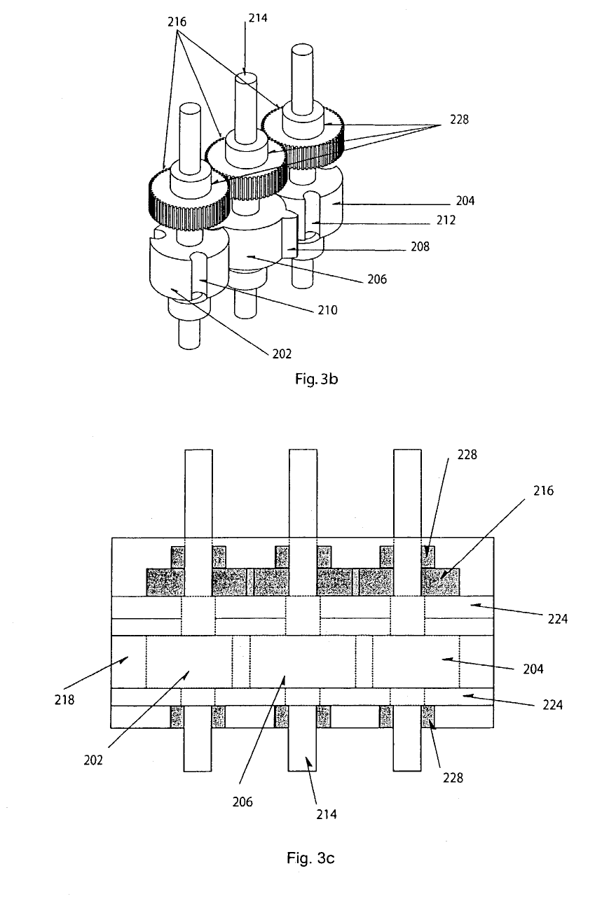

A gear assembly and/or shaft assembly (shown in FIGS. 3B-C) at each axis of rotation ensures the synchronous rotation of the extension rotor and the chamber rotor so that the extension moves unobstructed into and out of the chamber. The shaft assembly also provides a method of injecting or extracting power into or out of the system.

In addition, the present invention includes a rotor case 32 that houses the rotors and generally seals the rotors from ambient conditions. The rotor case typically includes several pieces to ease construction and assembly of the present invention, although this is not necessarily the case. The rotor case includes at least one interior cut-out in which the rotors reside. The cut-out defines one lobe for each rotor and is sized according to the particular rotor located in that lobe. For example, as seen in FIG. 1, the lobe 34 for the extension rotor must be able to accommodate the extension radius of the rotor. In this arrangement, a pressure cavity 36 is created between the extension rotor, the chamber rotor, and the rotor case (not including the roof and floor of the rotor case). The volume of the pressure cavity depends, inter alia, on the thickness of the rotor and the extension length. The lobe 38 associated with the chamber rotor need only accommodate the base radius of the chamber rotor.

The rotor case may include one or more intake and/or exhaust ports 40, 42, to facilitate operation of the system. The ports preferably have a flow path that is perpendicular or parallel to the axis of rotation of the rotors, although this is not necessarily the case.

The components of the present invention may be made out of any suitable material including metals, plastics, composites, and combinations thereof. Preferred materials are light weight, yet have the strength to withstand the operating conditions, i.e., pressure and temperature, of the present invention. Preferred materials are not brittle. Preferred metals include aluminum and/or steel, although other alloys are also suitable. Suitable plastics include those known to be useful in components of piston or turbine engines. Although typically made of a unitary construction, the components may have any suitable construction such as multiple layers bonded together or shells over a ballast. Indeed, for metal components any suitable construction method may be used including molding, with machining being preferred. Likewise plastic components may be made by any suitable method including injection molding and machining.

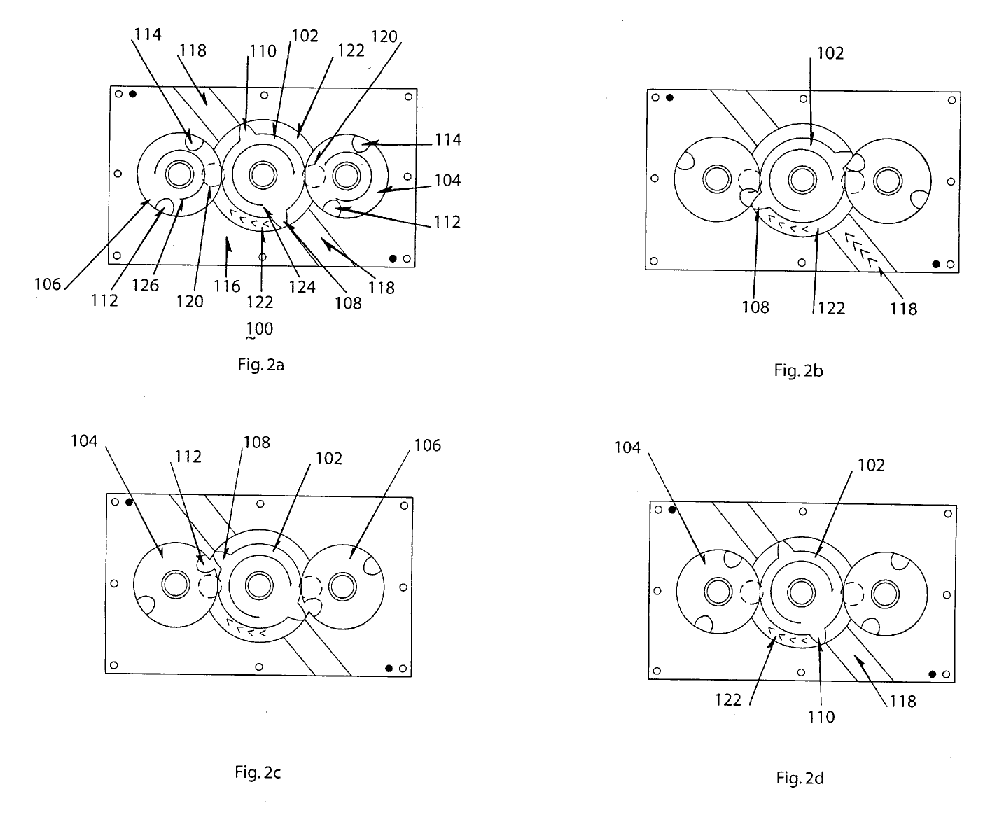

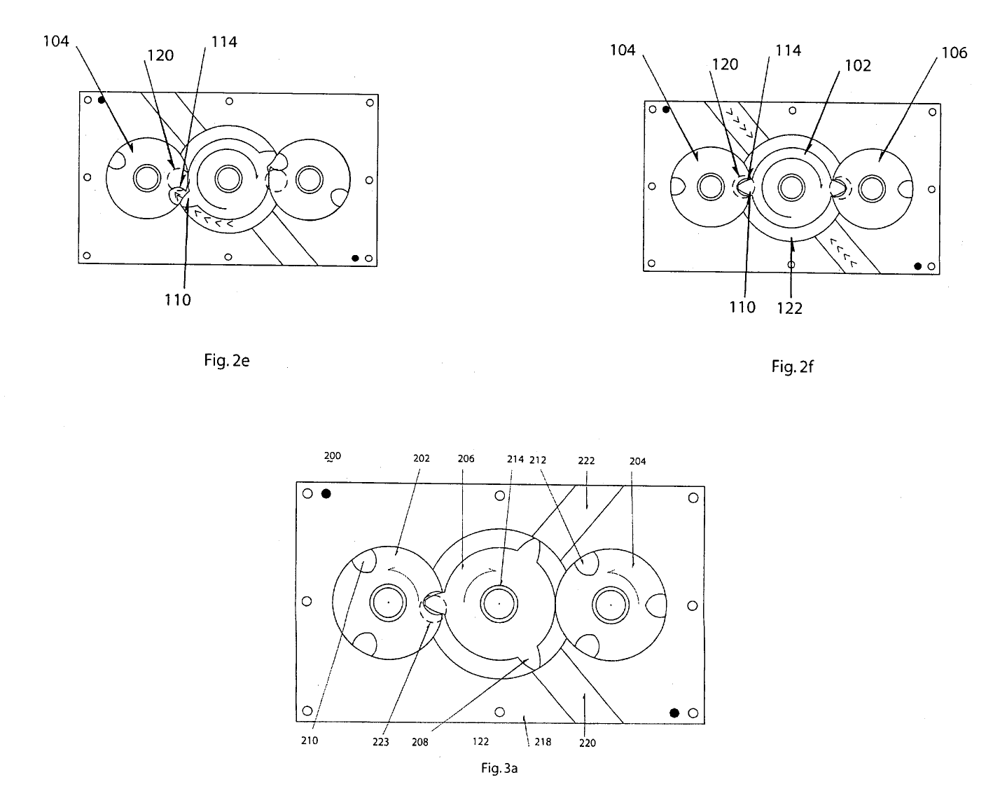

One embodiment of the compressor aspect of the present invention is shown in cross-section in FIG. 2A-F. The compressor 100 includes one extension rotor 102 and two chamber rotors 104, 106. In this particular embodiment, the extension rotor 102 has two extensions 108, 110, while the chamber rotors 104, 106 each have two chambers 112, 114. The rotor case 116 includes two intake ports 118 and two exhaust ports 120. A pressure cavity 122 exists between the rotor case 116, the base radius of the extension rotor 102 and the base radius of the chamber rotor 104 or 106. Arrows 124, 126 show the direction of rotation of the rotors. A power input shaft is connected to the extension rotor to drive the rotor, while a gear assembly on the shaft ensures that the chamber rotors are also driven and that the rotors have synchronous rotation.

The compressor of the present embodiment may be divided into two halves where both have identical operation. Each half includes one chamber rotor, one intake port and one exhaust port, while the extension rotor is shared between the halves. Consequently, only the operation of one half of the compressor needs to be discussed in detail. As seen in FIG. 2B, as the shaft turns the extension rotor 102, the first extension 108 sweeps out a volume in the pressure cavity 122, creating a vacuum on the backside of the first extension 108. A gas (shown as chevrons) is drawn into this vacuum through the intake port 118. Due to the synchronous rotation of the extension rotor 102 and the chamber rotors 104, 106, the first extension 108 will be accepted in and sweep through the first chamber 112 (FIG. 2C). After this, the second extension 110 will close the intake port 118 (FIG. 2D) and start the compression of the gas that was drawn up in the pressure cavity by the vacuum created on the sweep of the first extension. Because of a seal between the chamber rotor 104 and extension rotor 102, the gas will not be able to escape and will thus be compressed on the front side of the second extension 110 as it sweeps out a volume in the pressure cavity 122. Just before the second extension 110 enters the second chamber 114, the gas is compressed down to a small pressure cavity that is made up of only the extension rotor 102 and the chamber rotor 104. The gas is enclosed by the walls of the chamber and the extension (as shown in FIG. 2E). As the second extension 110 sweeps through the second chamber 114, the exhaust port 120 is opened by the movement of the chamber rotor 104. Effectively, the chamber rotor 104, acts as a rotary valve to open and close the exhaust port. With the exhaust port 120 open, the compressed gas is forced out of the compressor, as can be seen in FIG. 2F, where the extension rotor 102 is top-dead-center. This series of events is repeated for each half rotation of the extension rotor 102. As can be seen, the gas in the pressure cavity 122 is compressed to roughly the volume of the chamber 112 or 114. Since the chamber is significantly smaller than the cavity, the present invention can achieve significant rates of compression. Because the rotors have pure rotary motion, they may be run at high rpms without damaging the compressor or its components, thus achieving high compression rates.

To achieve maximal compression, the rotors, extensions, chambers and rotor case are sized and shaped so that seals are created wherever moving components contact or where a moving component contacts a stationary component. For example, the extension sealingly slides along the rotor case and the chamber wall during rotation of the rotors, while the extension rotor seals against the chamber rotor. Alternately, the rotors and rotor case need not be in contact with each other to provide for adequate sealing. Furthermore, the rotor case may include components that help seal the rotors from the ambient conditions.

A variety of valves and reservoirs may be used to increase the efficiency of the compressor. For example, a one-way valve located beyond the exhaust port may help prevent backflow. Furthermore, reservoirs may be used to as source of gas to be compressed or as storage for compressed gas.

In addition to gases, this device may operate on other fluids. For example, this device may pump liquids or gas/liquid mixtures. The location of the intake port may be adjusted to minimize the compression of the liquid while maximizing the volume of liquid being pumped. For example, the intake port may be moved closer to the exhaust port in the rotor case.

In an alternate mode of operation, the compressor embodiment of the present invention operates to efficiently produce heat, electricity and mechanical energy. By switching the intake port with the exhaust port and reversing the directions of rotation of the rotors, the energy in a high pressure intake gas can be converted to heat, electricity or mechanical energy. In essence, the operation of the compressor described above with respect to FIGS. 2A-F is run in reverse. In this alternate mode of operation, port 120 is an intake port and port 118 is an exhaust port. A high pressure reservoir may be used to introduce gases under pressure at the now intake port 120 into a pressure cavity that is made up of the chamber rotor 104 or 106 and the extension rotor 102. The high pressure gases push on the extensions 108, 110 causing the extension rotor 102 to rotate, which can be used to generate electricity or tapped as a source of mechanical energy. As the extension rotor 102 rotates, the pressure cavity increases in volume (it is now formed by the extension rotor, chamber rotor and the rotor case) causing the high pressure gases to expand and give off heat. Depending on the type of gas, the gas may also condense to a liquid. In any event, continued rotation of the extension rotor 102 opens the now exhaust port 118, allowing the gases/liquids to exit to a collection reservoir. The collection reservoir may be fluidly connected to the high pressure reservoir to recycle the collected gases/liquids. The radiated heat may be used to heat the high pressure reservoir, the collection reservoir, some other reservoir, or some other space. In one embodiment of this alternate mode of operation, the high pressure gas utilized is water vapor that is preferably created through the use of solar energy. The solar energy is thus efficiently turned into heat, electricity and/or mechanical energy.

One embodiment of the engine aspect of the present invention is shown in FIGS. 3A-C. In this embodiment, the engine 200 includes three rotors: two chamber rotors and one extension rotor. The first chamber rotor is called the combustion rotor 202, while the second chamber rotor is called the isolation rotor 204. The extension rotor is called the power rotor 206. In this particular embodiment, the power rotor 206 has three extensions 208, which correspond to the three chambers 210 of the combustion rotor 202 or the three chambers 212 of the isolation rotor 204. A power output shaft 214 is connected to the power rotor 206. A gear assembly 216, as seen in FIGS. 3B-C, synchronizes the rotation of the three rotors. A rotor case 218 also includes an intake port 220 and an exhaust port 222. A spark or glow plug 223 is located near the combustion rotor 202. As best seen in FIG. 3C, the rotor case 218 may include a variety of plates 224, gearboxes 226, and bearings 228 to facilitate operation of the engine. In addition, a variety of seals may be located on the plates to help seal the rotors from the ambient conditions.

In the engine, like the compressor, it is preferable that the rotors are sized and shaped so that seals are created wherever the rotors touch each other. Furthermore, the extension sealingly slides along the rotor case during rotation of the rotors. Alternately, the rotors and rotor case need not be in contact with each other to provide for adequate sealing for operation.

Unlike the compressor, the extensions are sized and shaped so that they do not touch the chamber wall when the extension rotor is top-dead-center. This may be accomplished by providing a slightly shortened extension or by providing a plateau extension where the apex of the extension has been flattened. Alternately, this may be accomplished by a providing a slightly deepened chamber or by providing a chamber wall where the shape has been adjusted to assure that the extension apex does not contact the chamber wall when then extension rotor is top-dead-center.

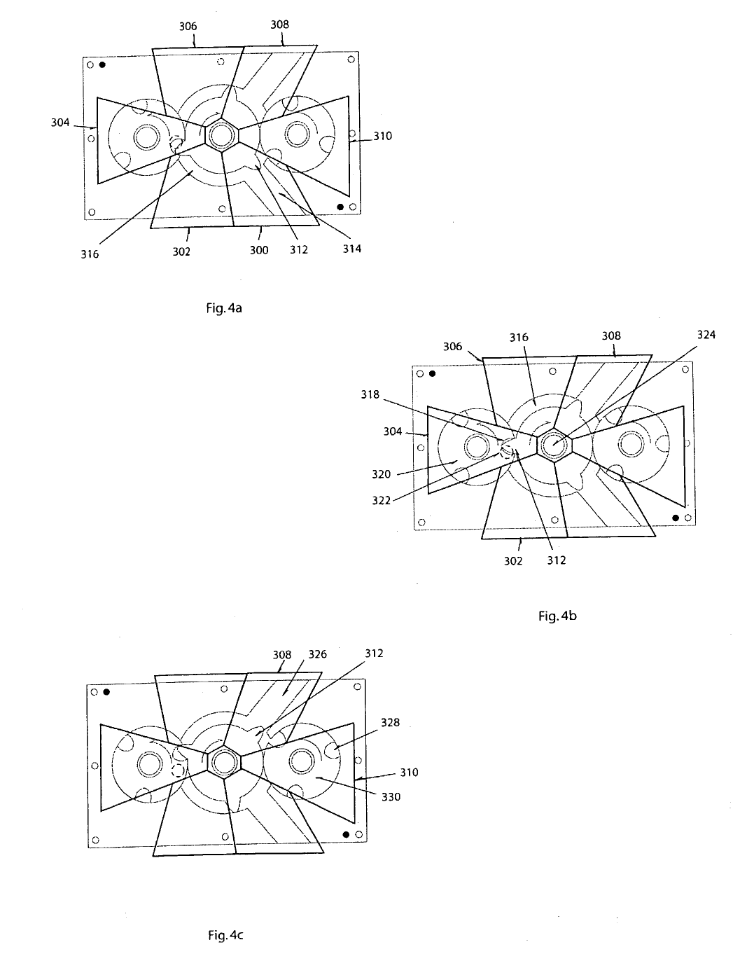

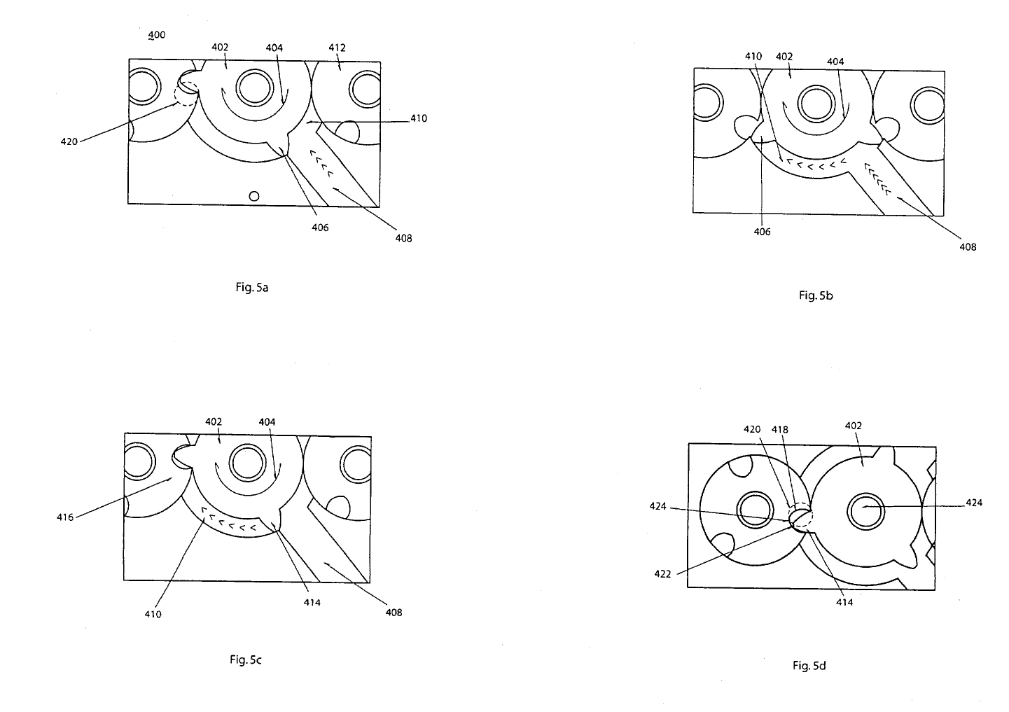

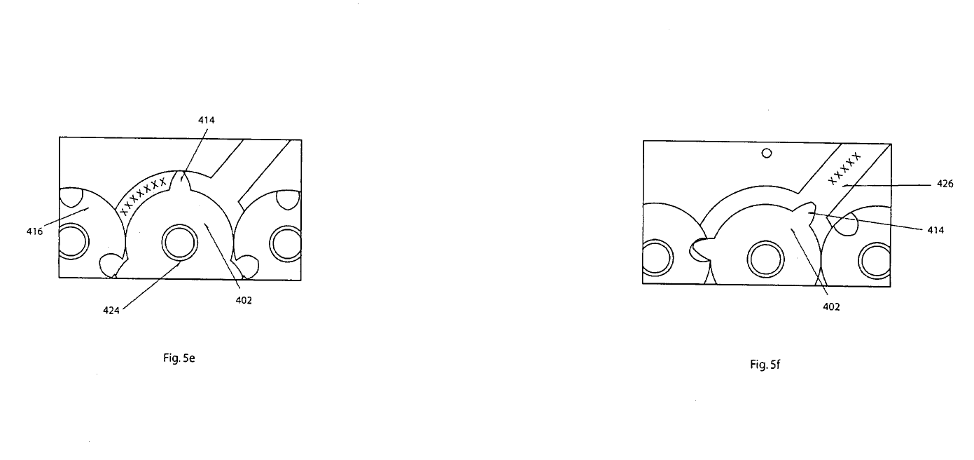

FIGS. 4A-C show a general overview of the operation of this embodiment of the engine aspect of this invention. Although no strict boundaries exist, the engine generally has six zones, which are: intake 300, compression 302, combustion 304, power 306, exhaust 308 and isolation 310. In the intake zone 300, the extensions 312 sweep through to alternately close then open the intake port 314 to the introduce intake gases, i.e., air/fuel mixture. In the compression zone 302, the extensions 312 sweep through the pressure cavity 316 to compress the intake gases. In the combustion zone 304, the extensions 312 cooperate with the chambers 318 of combustion rotor 320 to provide a pressure cavity with compressed intake gases that are ignited by a spark plug 322 to create the propelling combustion gases. In the power zone 306, the ignited combustion gases expand in the pressure cavity, pushing on the extension 312 and providing power to the power shaft 324 of the engine. In the exhaust zone 308, the extensions 312 sweep through to alternately open and close the exhaust port 326 and expel exhaust gases. In the isolation zone 310, the extensions 312 cooperate with the chambers 328 of the isolation rotor 330 to prevent exhaust gases from mixing with the intake gases.

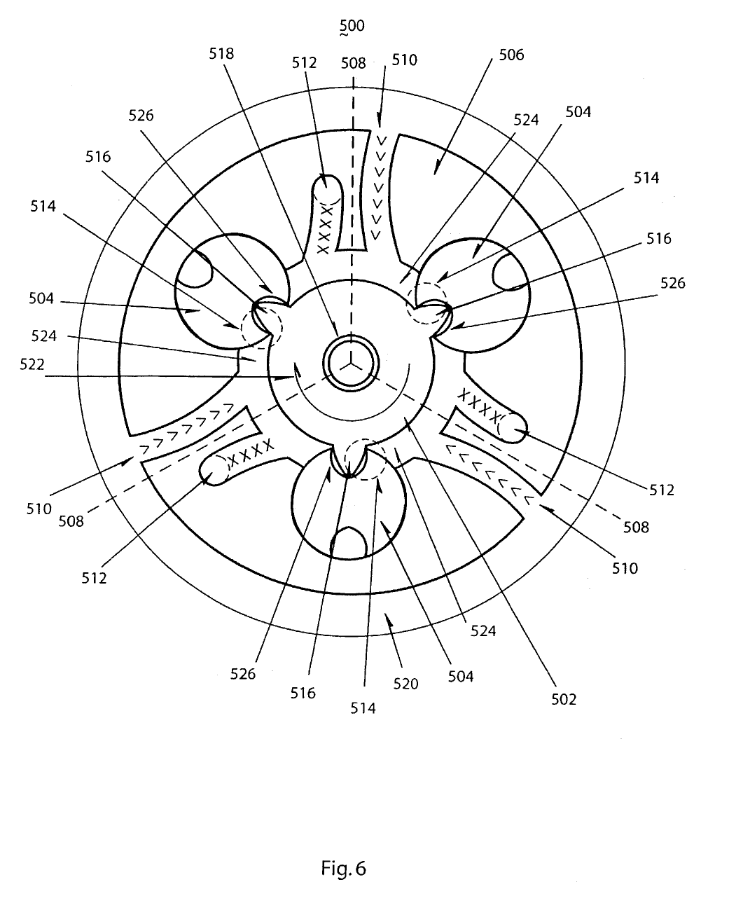

With reference to FIGS. 5A-G, a more detailed description of the operation of the engine is provided. As seen in FIG. 5A, in the engine 400, as the power rotor 402 rotates forward in the direction of the arrow 404, the first extension 406 opens the intake port 408 to allow the intake gases (shown as chevrons) into the cavity 410. The intake gases are prevented from back flowing by the seal between the power rotor 402 and the isolation rotor 412. As the first extension 406 continues to rotate forward, as seen in FIG. 5B, it creates a vacuum on its backside and draws the intake gases into the cavity 410 from intake port 408. As seen in FIG. 5C, further rotation of the power rotor 402 causes the second extension 414 to close the intake port 408 and seal the cavity 410. Continued rotation causes the second extension 414 to compress the intake gases in the cavity 410 against the combustion rotor 416 and the rotor case. The seal between the power rotor 402 and the combustion rotor 416 prevents the compressed intake gases from escaping. As seen in FIG. 5D, the intake gases move into the chamber 418 in front of the second extension 414 as it begins to sweep through the chamber 418. A spark plug 420 ignites the compressed intake gases just before the power rotor 402 reaches top-dead-center. Because the extension apex 422 is slightly spaced from the chamber nadir 423, the extension apex 422 does not contact the chamber wall. Consequently, the expanding combustion gases move from the front side of the second extension 414 to the backside, pushing on the backside of the second extension and transfer power to the power shaft 424. As seen in FIG. 5E, the combustion gases (shown as crosses) are prevented from back flowing by the seal between the power rotor 402 and the combustion rotor 416 and transfer power to the power shaft 424. As seen in FIG. 5F, continued rotation opens the exhaust port 426 and allows the combustion gases to vent without the need for valves or other mechanical devices. Indeed, the next extension effectively forces the majority of the exhaust gases out through the exhaust port 426 as it sweeps through. As seen in FIG. 5G, any remaining exhaust gases are effectively isolated from the intake zone. Similar to as discussed above with respect to the combustion zone, the extension apex 428 does not contact the valve rotor 428 and forces any remaining exhaust gases from front side of the extension 414 to the backside of the extension. As the extension 414 leaves the chamber 430, it seals the chamber from the intake zone, such that any remaining exhaust gases are trapped in the chamber. This completes one cycle of the engine and is roughly equivalent to a two or four -cycle engine. The process starts again with the intake of gases at intake port 408.

In a second embodiment of the engine aspect of the present invention, a single power rotor may be associated with more than two chamber rotors. As seen in FIG. 6, the engine 500 has a power rotor 502 associated with three combustion rotors 504 located in a rotor case 506. As discussed below, the isolation rotor is not used in this embodiment. The engine is divided into three identical operational zones, as roughly shown by the dotted lines 508. Each zone has a chamber rotor 504, an intake port 510, an exhaust port 512 and a spark plug 514. The power rotor 502 has three extensions 516 and a power output shaft 518. The intake port 510 is generally perpendicular to the axis of rotation of the power rotor. The exhaust port 512 has a portion that perpendicular and a portion parallel to the axis of rotation.

As discussed in more detail below, the engine 500 may also includes a pressurization ring 520 to evenly distribute pressurized intake gases around the rotor case 506. Other structures in the engine may be used to deliver the pressurized intake gases. The intake gases may be pressurized by any suitable device such as a supercharger, a turbocharger, a root blower and/or the compressor aspect of the present invention.

The operation of this embodiment is similar to the first embodiment of the engine aspect, but with some significant differences. As with the first embodiment, this engine has the same six zones. Rather then being spread across the entire perimeter of the power rotor, in the present embodiment, the six zones are roughly spread across only a third of the perimeter of the power rotor. This effectively increases the power density of the engine by replacing three power rotors, three combustion rotors and three valve rotors with one power rotor and three combustion rotors.

In place of the isolation rotor, pressurized intake gases are used to keep the intake gases separate from the exhaust gases. The pressurized intake gases effectively create barrier between each operational zone (roughly located where dotted line 508 is located). The pressurized barrier prevents exhaust gases from mixing with the intake gases, eliminating the need for the isolation rotor. The pressurized gases also turbo charge the engine.

Pressurized intake gases (shown as chevrons) are introduced at the intake ports 510. The curved intake ports direct the intake gases in the direction of rotation of the power rotor 502 (shown by arrow 522), thus creating the barrier between the intake and exhaust gases.

As in the other embodiments and aspects of this invention, the extension 516 compresses the intake gases as it sweeps them from the cavity 524 into the chamber 526 of the combustion rotor 504. Just before the power rotor 502 reaches top-dead-center, the spark plug 514 ignites the intake gases. The combustion gases push the extension 516, transferring power to the shaft 518. The exhaust gases (shown by crosses) are vented out the exhaust port 512. As mentioned above, the pressurized barrier of intake gases prevents the exhaust gases from mixing with the intake gases.

The spark plugs may be fired in sequence, but preferably the spark plugs are fired simultaneously, effectively tripling the power produced by the engine. Indeed, an additional power multiplier could be obtained through the use of additional extensions on the power rotor in combination with additional combustion rotors.

Also contemplated is combinatorial use of the pump, compressor and engine aspects of this invention. For example, several compressors may be serially connected such that the exhaust port of one is connected to intake port of the next, thus allowing gases to be compressed several times over. Also, several pumps acting on liquids can be serially connected to effectively act as “repeaters” to maintain a liquid flowing at a particular speed or under a particular pressure over a distance. Also, compressors could be used in parallel to greatly increase the rate at which compression/pumping could be accomplished. Likewise, several engines could be used in combination to generate a power for a single transmission, vehicle and/or machine. Furthermore, engines and compressors/pumps could be used in combination. For example, the power output shaft of the engine could be used to drive the power input shaft of the compressor. Also, the compressor could provide compressed intake gases to the engine or a pump could provide coolant fluid for the engine.

The present invention differs from known compressors and pumps in its operation. As discussed above, the rotors utilized in the present invention work together, i.e., they cooperate, to compress or to pump the fluid. Other components may also be part of the cooperative compression or pumping process, but unlike other devices, the rotors, at some point in their rotation, cooperate with each other to compress or pump the fluid being acted upon.

The present invention differs from known engines in several significant ways. Most importantly, the present engine is a pure non-eccentric engine, which significantly distinguishes it from a majority of known engines including piston and Wankel engines. As for turbine engines, which are also purely non-eccentric, the present invention is not a momentum turbine engine, but rather may be characterized as a pressure turbine engine. As discussed above, in known turbine engines, when the fan blades are prevented from rotating, the fluid merely continues to flow through the engine and no backpressure is created. In the present invention, if the power rotor is prevented from rotating, the intake gases cannot continue to flow through the engine and around the power rotor. This causes the intake gases to stack up and create backpressure. Hence, the characterization of the present engine as a pressure turbine engine as opposed to a momentum turbine engine. Likewise, the compressor of the present invention is also a pressure turbine device.

Given the significant differences between the present invention and known engines, easy comparison is not possible. A comparison among different engine types (turbine versus piston) is difficult because most engines are usually only compared within an engine type, i.e., one piston engine is compared to another piston engine. However, some comparison can be undertaken using some general properties of engines such as horsepower, fuel efficiency, emissions, weight, torque and power density. Tables I & II show comparisons of several engines including an aircraft gas turbine engine, three marine piston engines and four theoretical engines according to the present invention (called Pressure Turbine Engines or PTEs). All the PTE would be built according to the embodiment shown in FIGS. 3-5. All weight calculations of the PTEs are based on using aluminum as the predominant material for the engine. The calculation of the weight of PTE II and PTE III would include accessories such as a gear train or a transmission. Calculations of horsepower in PTE III and PTE IV include the assumption that they would be turbocharged. While Table I compares physical characteristics, Table II compares operational characteristics. For known engine types, values for the attributes are drawn from published resources or calculated from published values. For the present inventive engines, the attribute values are calculated based on theory or from prototypes.

TABLE I

| | Weight | Displacement | | | |
|---|---|---|---|---|---|
| Type | (lb) | (in³) | Size (in³) | Parts | Emissions |
| Aircraft Gas | 210 | — | ˜20664 | ˜500 | High |
| Turbine | | | | | |
| Marine Diesel | 2500 | 641 | ˜122400 | ˜750 | Low |
| Marine Diesel* | 900 | 257 | ˜30576 | ˜750 | Low |
| Marine Gas | 940 | 350 | ˜28380 | ˜750 | Low |
| PTE I | 230 | 54 | ˜3388 | ˜12 | Very Low |
| PTE II | 300 | 54 | ˜3388 | ˜12 | Very Low |
| PTE III* | 350 | 54 | ˜3388 | ˜12 | Very Low |
| PTE IV* | 300 | 54 | ˜3388 | ˜12 | Very Low |

*These engines are turbocharged

From Table I it can be seen that the PTEs have several advantageous physical characteristics compared to known engines. For example, PTEs weigh slightly more than the gas turbine engine, but significantly less than the marine engines. With respect to displacement, the PTEs have a displacement that is several times smaller than the marine engines. The overall physical size of the PTEs is at least one order of magnitude smaller than the other engines, making the PTEs suitable for a larger number of applications. Also, several PTEs could be used in the space of one traditional engine. PTEs also have significantly fewer parts, which reduces costs of manufacturing assembly and maintenance, as well as dramatically increasing the reliability of the PTEs. While not wanting to be limited, it is believed that PTEs will be clean burning engines because of the long burn time possible in PTEs given that the pressure cavity lengthens during combustion. Given the proper air/fuel mixture, essentially complete combustion can occur in the cavity between spark plug and the exhaust port. The length of the burn path ensures an essentially complete burn.

TABLE II

| | | | Fuel | | Power- | Power |
|---|---|---|---|---|---|---|
| | | | Efficiency | | Displacement | Density |
| Type | HP | RPM | (lb/hr-hp) | Torque | (hp/in³) | (hp/lb) |
| Aircraft Gas Turbine | 380 | 30000 | 0.635 | 66 | — | 1.8 |
| Marine Diesel | 250 | 2000 | 0.374 | 670 | 0.37 | 0.10 |
| Marine Diesel* | 255 | 3600 | 0.42 | 372 | 0.99 | 0.28 |
| Marine Gas | 195 | 3500 | 0.35 | 337 | 0.56 | 0.21 |
| PTE I | 200 | 8000 | 0.35 | 130 | 4.6 | 0.86 |
| PTE II | 200 | 8000 | 0.35 | 130 | 4.6 | 0.67 |
| PTE III* | 400 | 16000 | 0.35 | 130 | 7.4 | 1.15 |
| PTE IV* | 400 | 16000 | 0.35 | 130 | 7.4 | 1.33 |

*These engines are turbocharged.

From Table II it can be seen that the PTEs have several advantageous operational characteristics compared to known engines. For example, despite their small weight, size and displacement, the PTEs have horsepower ratings that are higher than any other engine. The operational rpm (the speed at which the power rotor turns) of the PTEs is also significantly higher than the marine piston engines. The fuel efficiency of the PTEs is at least comparable to the known engines, if not slightly better than most of the known engines. The output torque of the PTEs is not as high as the output of the marine engines, but is nonetheless sufficient for a large variety of uses. The PTEs separate themselves from known engines when the size and weight of the PTEs is factored into the horsepower rating. As can be seen with respect to power-displacement, the PTEs are at least 4.6 times better than the best marine engine, and at least 12 times better than the worst marine engine. The power density rating of the PTEs shows similar results with respect to the marine engines. The PTEs are far more power dense than the marine engines. With respect to the gas turbine engine, the PTEs are less power dense; however, the PTEs have other attributes that make them desirable in view of gas turbine engines including smaller size, significantly fewer parts, lower emissions and better fuel efficiency.

One other important characteristic of the present PTEs is that there is a linear relationship between rpm and output horsepower; as the rpm increases, so does horsepower with a theoretical maximum limited only by the rpm of the power rotor. The horsepower rating of known engines is usually given at a specific rpm, and there is a maximum horsepower after which increasing the rpm will not increase the horsepower. Like the compressor, the PTEs have a linear relationship between rpm and amount of intake gases pump. Since all intake gases will be combusted, there is a linear correlation between amount of intake gases and the horsepower. Consequently, there is also a linear relationship between rpm and horsepower; as the rpm of the power rotor increases, so does the output horsepower of the present PTEs.

While the invention has been specifically described in connection with certain specific embodiments thereof, it is to be understood that this is by way of illustration and not of limitation, and the scope of the appended claims should be construed as broadly as the prior art will permit.

What is claimed is:

1. An apparatus, comprising:
at least one chamber rotor including at least one chamber;
at least one extension rotor including at least one extension; and
a rotor case that houses the rotors,
wherein a pressure cavity is at least transiently formed by the at least one extension rotor and the at least one chamber rotor.

2. The apparatus of claim 1, wherein the rotors and the rotor case combine to form the pressure cavity.

3. The apparatus of claim 1, wherein the pressure cavity is formed by the at least one extension rotor, the at least one chamber rotor and the rotor case.

4. The apparatus of claim 1, further comprising:
a shaft attached to the at least one extension rotor; and
a gear assembly attached to the rotors and adapted to insure the synchronous rotation of the rotors.

5. The apparatus of claim 4, wherein the shaft is a power input shaft.

6. The apparatus of claim 4, wherein the shaft is a power output shaft.

7. The apparatus of claim 1, further comprising:
at least a pair of ports located in the rotor case, wherein at least one port is an intake port and at least one port is an exhaust port.

8. The apparatus of claim 7, wherein the exhaust port is located adjacent to the transiently formed pressure chamber.

9. The apparatus of claim 7, wherein the intake port is located adjacent to the transiently formed pressure chamber.

10. The apparatus of claim 1, wherein the at least one extension rotor includes at least two extensions.

11. The apparatus of claim 1, wherein the at least one extension rotor includes at least three extensions.

12. The apparatus of claim 1, further including at least two chamber rotors.

13. The apparatus of claim 1, further including at least three chamber rotors.

14. The apparatus of claim 1, wherein, during rotation of the rotors, the at least one extension slidingly seals against the rotor case.

15. The apparatus of claim 1, wherein, during rotation of the rotors, the at least one extension slidingly seals against a chamber wall.

16. The apparatus of claim 1, wherein, during rotation of the rotors, the at least one extension rotor seals against the at least one chamber rotor.

17. A compressor, comprising:
at least one chamber rotor including at least one chamber;
at least one extension rotor including at least one extension adapted to be received in the chamber when the rotors are synchronously rotated;
a power input shaft attached to the extension rotor;
a gear assembly attached to the rotors adapted to insure the synchronous rotation of the rotors; and
a rotor case that houses the rotors and having an intake port and an exhaust port.

18. The compressor of claim 17, further comprising two extension rotors and one chamber rotor.

19. The compressor of claim 17, further comprising a pressure cavity at least transiently formed by the at least one extension rotor and the at least one chamber rotor.

20. The apparatus of claim 19, wherein the pressure cavity is at least transiently formed by the at least one extension rotor, the at least one chamber rotor and the rotor case.

21. An engine, comprising:
at least one combustion rotor including at least one chamber;
at least one power rotor including at least one extension adapted to be received in the chamber when the rotors are synchronously rotated;
at least one spark plug for each combustion rotor;
a power output shaft attached to the power rotor;
a gear assembly attached to the rotors adapted to insure the synchronous rotation of the rotors; and
a rotor case that houses the rotors and having an intake port and an exhaust port.

22. The engine of claim 21, further comprising at least one isolation rotor including at least one chamber.

23. The engine of claim 21, further comprising a compressor attached to the intake port.

24. The engine of claim 23, wherein the compressor is one according to claims 1 or 15.

25. The engine of claim 21, further comprising at least three combustion rotors for each power rotor.

26. A method of compressing a fluid, comprising:
introducing a fluid into a pressure cavity formed by a rotor case, at least one extension rotor, and at least one chamber rotor; and
rotating the at least one extension rotor, having at least one extension, so that the at least one extension sweeps the fluid into a pressure cavity formed by the at least one chamber rotor.

27. The method of claim 26, wherein the fluid is introduced through an intake port.

28. The method of claim 27, wherein the introduction is valved by the chamber rotor.

29. The method of claim 27, wherein the introduction is valved by the at least one extension.

30. The method of claim 26, further comprising exhausting the fluid through an exhaust port.

31. The method of claim 30, wherein the exhausting is valved by the chamber rotor.

32. The method of claim 30, wherein the exhausting is valved by the at least one extension.

33. The method of claim 26, further comprising igniting the fluid.
